(19) United States
(12) Patent Application Publication
(10) Pub. No.: US 2012/0042754 A1
(43) Pub. Date: Feb. 23, 2012

(54) Socket Assembly Having Insulating Effect

(76) Inventor: Timmy Chen, Taichung City (TW)

(21) Appl. No.: 12/857,639

(22) Filed: Aug. 17, 2010

(51) Int. Cl. B25B 13/06; B25B 23/00

(52) U.S. Cl. 81/121.1; 81/180.1

(57) ABSTRACT

A socket assembly includes an insulating outer layer, a workpiece connector mounted in a first end of the insulating outer layer, and a tool connector mounted in a second end of the insulating outer layer and spaced from the workpiece connector. Thus, the separation wall of the insulating outer layer between the workpiece connector and the tool connector can isolate the workpiece connector from the tool connector so that when an electric current is electrically conducted to the workpiece connector through the workpiece, the electric current will not be delivered from the workpiece connector to the tool connector, thereby preventing an operator from directly contacting with the electric current so as to protect the operator's safety.

### BACKGROUND OF THE INVENTION

1. Field of the Invention

The present invention relates to a hand tool and, more particularly, to a socket assembly.

2. Description of the Related Art

A conventional socket has a first end provided with a workpiece connecting portion and a second end provided with a tool connecting portion. The workpiece connecting portion of the socket has an inner portion formed with a hexagonal driving hole for driving a workpiece, such as a bolt, nut and the like. The tool connecting portion of the socket has an inner portion formed with a square driven hole that is driven by a driving tool, such as a ratchet wrench and the like. Thus, the driving tool can drive and rotate the workpiece by aid of the socket. However, the socket is made of metal that will conduct the electricity so that when an electric current is electrically conducted to the socket through the workpiece, the electric current from the workpiece will be delivered through the socket to an operator, thereby causing danger to the operator.

### BRIEF SUMMARY OF THE INVENTION

In accordance with the present invention, there is provided a socket assembly, comprising an insulating outer layer, a workpiece connector mounted in a first end of the insulating outer layer, and a tool connector mounted in a second end of the insulating outer layer and spaced from the workpiece connector.

The insulating outer layer has a mediate portion provided with a separation wall located between the workpiece connector and the tool connector to isolate the workpiece connector from the tool connector. The first end of the insulating outer layer has an inner portion formed with a receiving chamber to receive the workpiece connector. The second end of the insulating outer layer has an inner portion formed with a receiving recess to receive the tool connector. The receiving chamber of the insulating outer layer has a bottom wall formed with at least one positioning hole. The receiving recess of the insulating outer layer has a bottom wall formed with at least one positioning bore. The workpiece connector has a bottom wall provided with at least one positioning block locked in the positioning hole of the insulating outer layer. The tool connector has a bottom wall provided with at least one positioning piece locked in the positioning bore of the insulating outer layer.

The receiving chamber of the insulating outer layer has a peripheral wall formed with a retaining flange. The receiving recess of the insulating outer layer has a peripheral wall formed with a retaining rib. The workpiece connector has a peripheral wall formed with a retaining groove locked onto the retaining flange of the insulating outer layer. The tool connector has a peripheral wall formed with a retaining channel locked onto the retaining rib of the insulating outer layer. The positioning block of the workpiece connector has a rectangular shape. The positioning piece of the tool connector has a rectangular shape. The workpiece connector has an inner portion formed with a driving hole. The positioning block of the workpiece connector is isolated from the driving hole. The tool connector has an inner portion formed with a driven hole. The positioning piece of the tool connector is isolated from the driven hole. The positioning piece of the tool connector and the positioning block of the workpiece connector are arranged in a staggered manner. The workpiece connector is fully received in and flush with the receiving chamber of the insulating outer layer. The tool connector is fully received in and flush with the receiving recess of the insulating outer layer. The positioning block of the workpiece connector has an arc-shaped profile, and the positioning piece of the tool connector has an arc-shaped profile.

The primary objective of the present invention is to provide a socket assembly having insulating effect.

According to the primary advantage of the present invention, the separation wall of the insulating outer layer between the workpiece connector and the tool connector can isolate the workpiece connector from the tool connector so that when an electric current is electrically conducted to the workpiece connector through the workpiece, the electric current will not be delivered from the workpiece connector to the tool connector, thereby preventing an operator from directly contacting with the electric current so as to protect the operator's safety.

According to another advantage of the present invention, the positioning block of the workpiece connector is locked in the positioning hole of the insulating outer layer, and the retaining groove of the workpiece connector is locked onto the retaining flange of the insulating outer layer, so that the workpiece connector is locked in the insulating outer layer solidly and stably and will not be detached from the insulating outer layer.

According to a further advantage of the present invention, the positioning piece of the tool connector is locked in the positioning bore of the insulating outer layer, and the retaining channel of the tool connector is locked onto the retaining rib of the insulating outer layer, so that the tool connector is locked in the insulating outer layer solidly and stably and will not be detached from the insulating outer layer.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a socket assembly in accordance with the preferred embodiment of the present invention.

FIG. 2 is a front cross-sectional view of the socket assembly as shown in FIG. 1.

FIG. 3 is a perspective view of a tool connector of the socket assembly as shown in FIG. 1.

FIG. 4 is a perspective view of a workpiece connector of the socket assembly as shown in FIG. 1.

FIG. 5 is a perspective view of a socket assembly in accordance with another preferred embodiment of the present invention.

FIG. 6 is a perspective view of a socket assembly in accordance with another preferred embodiment of the present invention.

FIG. 7 is a perspective view of a socket assembly in accordance with another preferred embodiment of the present invention.

FIG. 8 is a perspective view of a socket assembly in accordance with another preferred embodiment of the present invention.

### DETAILED DESCRIPTION OF THE INVENTION

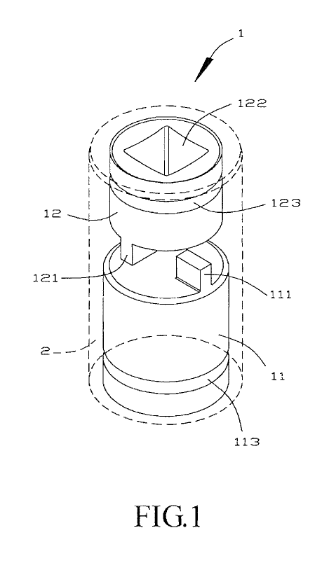

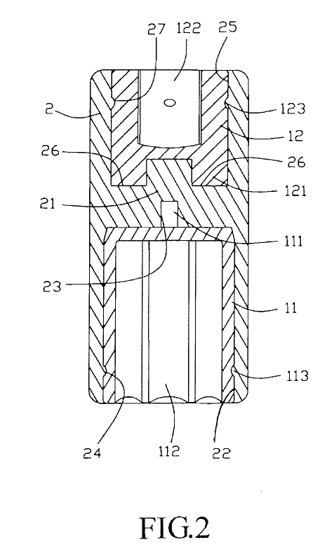

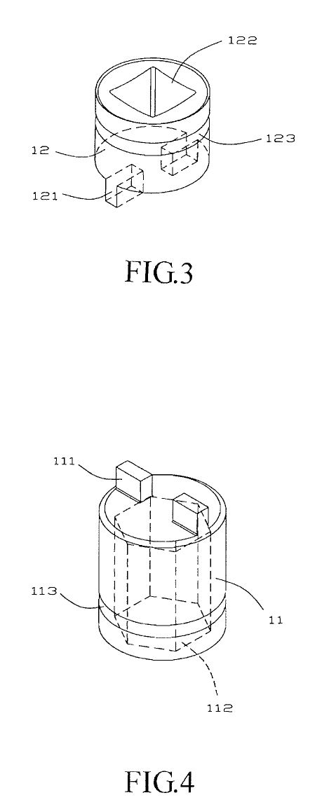

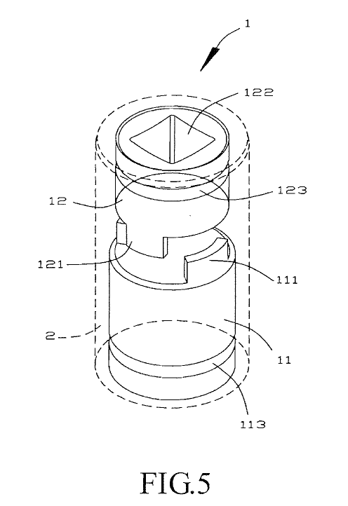

Referring to the drawings and initially to FIGS. 1-4, a socket assembly 1 in accordance with the preferred embodiment of the present invention comprises an insulating outer layer 2, a workpiece connector 11 mounted in a first end of the insulating outer layer 2, and a tool connector 12 mounted in a second end of the insulating outer layer 2 and spaced from the workpiece connector 11.

The insulating outer layer 2 has a mediate portion provided with a separation wall 21 located between the workpiece connector 11 and the tool connector 12 to isolate the workpiece connector 11 from the tool connector 12.

The first end of the insulating outer layer 2 has an inner portion formed with a receiving chamber 22 to receive the workpiece connector 11.

The receiving chamber 22 of the insulating outer layer 2 has a bottom wall formed with at least one positioning hole 23 and has a peripheral wall formed with a retaining flange 24. The retaining flange 24 of the insulating outer layer 2 has an annular shape.

The second end of the insulating outer layer 2 has an inner portion formed with a receiving recess 25 to receive the tool connector 12. The receiving recess 25 of the insulating outer layer 2 has a bottom wall formed with at least one positioning bore 26 and has a peripheral wall formed with a retaining rib 27. The retaining rib 27 of the insulating outer layer 2 has an annular shape.

The workpiece connector 11 is fully received in and flush with the receiving chamber 22 of the insulating outer layer 2. The workpiece connector 11 is preferably a socket and has an inner portion formed with a hexagonal driving hole 112 for driving a workpiece, such as a bolt, nut and the like. The workpiece connector 11 has a bottom wall provided with at least one positioning block 111 locked in the positioning hole 23 of the insulating outer layer 2. The positioning block 111 of the workpiece connector 11 has a rectangular shape and is isolated from the driving hole 112. The workpiece connector 11 has a peripheral wall formed with a retaining groove 113 locked onto the retaining flange 24 of the insulating outer layer 2. The retaining groove 113 of the workpiece connector 11 has an annular shape.

The tool connector 12 is fully received in and flush with the receiving recess 25 of the insulating outer layer 2. The tool connector 12 has an inner portion formed with a square driven hole 122 that is driven by a driving tool, such as a ratchet wrench and the like. The tool connector 12 has a bottom wall provided with at least one positioning piece 121 locked in the positioning bore 26 of the insulating outer layer 2. The positioning piece 121 of the tool connector 12 has a rectangular shape and is isolated from the driven hole 122. Preferably, the positioning piece 121 of the tool connector 12 and the positioning block 111 of the workpiece connector 11 are arranged in a staggered manner. The tool connector 12 has a peripheral wall formed with a retaining channel 123 locked onto the retaining rib 27 of the insulating outer layer 2. The retaining channel 123 of the tool connector 12 has an annular shape.

When in use, the separation wall 21 of the insulating outer layer 2 is located between the workpiece connector 11 and the tool connector 12 to isolate the workpiece connector 11 from the tool connector 12 so that when an electric current is electrically conducted to the workpiece connector 11 through the workpiece, the electric current will not be delivered from the workpiece connector 11 to the tool connector 12, thereby preventing an operator from directly contacting with the electric current so as to protect the operator's safety. In addition, the positioning block 111 of the workpiece connector 11 is locked in the positioning hole 23 of the insulating outer layer 2, and the retaining groove 113 of the workpiece connector 11 is locked onto the retaining flange 24 of the insulating outer layer 2, so that the workpiece connector 11 is locked in the insulating outer layer 2 solidly and stably and will not be detached from the insulating outer layer 2. Further, the positioning piece 121 of the tool connector 12 is locked in the positioning bore 26 of the insulating outer layer 2, and the retaining channel 123 of the tool connector 12 is locked onto the retaining rib 27 of the insulating outer layer 2, so that the tool connector 12 is locked in the insulating outer layer 2 solidly and stably and will not be detached from the insulating outer layer 2. Further, the positioning block 111 of the workpiece connector 11 is isolated from the driving hole 112 of the workpiece connector 11, and the positioning piece 121 of the tool connector 12 is isolated from the driven hole 122 of the tool connector 12 to prevent the insulating outer layer 2 from being infiltrated into the driving hole 112 of the workpiece connector 11 and the driven hole 122 of the tool connector 12 during the plastic injection molding process.

As shown in FIG. 5, the positioning block 111 of the workpiece connector 11 has an arc-shaped profile, and the positioning piece 121 of the tool connector 12 has an arc-shaped profile.

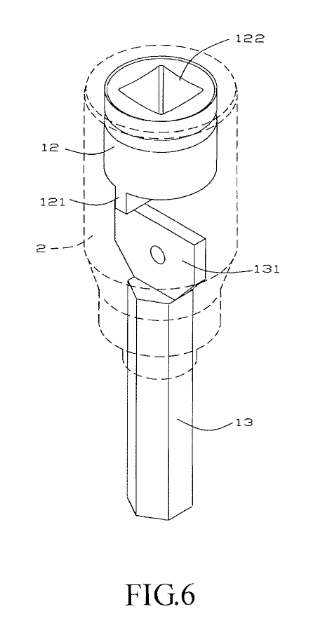

As shown in FIG. 6, the workpiece connector 13 is preferably a hexagonal driver and has at least one positioning block 131.

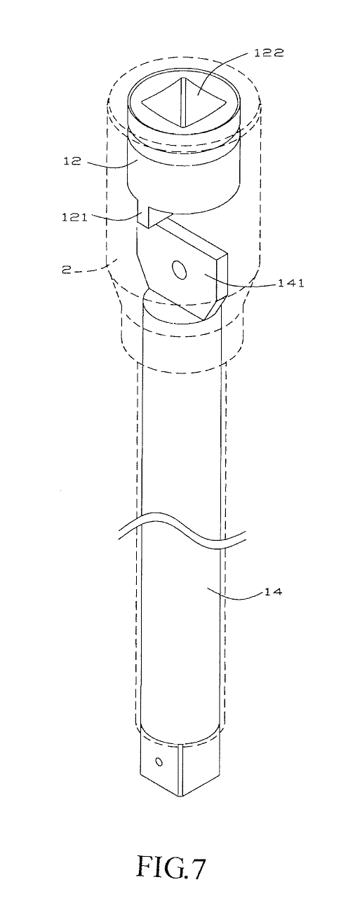

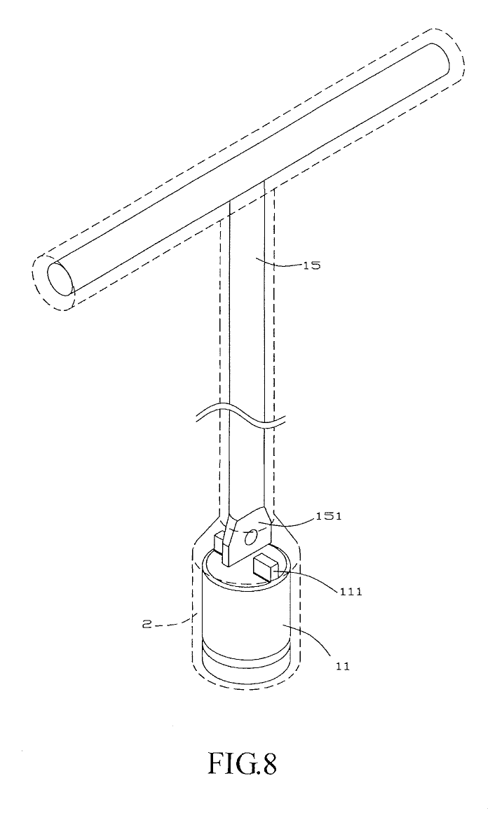

As shown in FIG. 7, the workpiece connector 14 is preferably a connecting rod and has at least one positioning block 141.

As shown in FIG. 8, the tool connector 15 is preferably a T-shaped connecting tool and has at least one positioning piece 151.

Accordingly, the separation wall 21 of the insulating outer layer 2 between the workpiece connector .11 and the tool connector 12 can isolate the workpiece connector 11 from the tool connector 12 so that when an electric current is electrically conducted to the workpiece connector 11 through the workpiece, the electric current will not be delivered from the workpiece connector 11 to the tool connector 12, thereby preventing an operator from directly contacting with the electric current so as to protect the operator's safety. In addition, the positioning block 111 of the workpiece connector 11 is locked in the positioning hole 23 of the insulating outer layer 2, and the retaining groove 113 of the workpiece connector 11 is locked onto the retaining flange 24 of the insulating outer layer 2, so that the workpiece connector 11 is locked in the insulating outer layer 2 solidly and stably and will not be detached from the insulating outer layer 2. Further, the positioning piece 121 of the tool connector 12 is locked in the positioning bore 26 of the insulating outer layer 2, and the retaining channel 123 of the tool connector 12 is locked onto the retaining rib 27 of the insulating outer layer 2, so that the tool connector 12 is locked in the insulating outer layer 2 solidly and stably and will not be detached from the insulating outer layer 2.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A socket assembly, comprising:
an insulating outer layer;
a workpiece connector mounted in a first end of the insulating outer layer; and
a tool connector mounted in a second end of the insulating outer layer and spaced from the workpiece connector;
wherein the insulating outer layer has a mediate portion provided with a separation wall located between the workpiece connector and the tool connector to isolate the workpiece connector from the tool connector.

2. The socket assembly of claim 1, wherein
the first end of the insulating outer layer has an inner portion formed with a receiving chamber to receive the workpiece connector;
the second end of the insulating outer layer has an inner portion formed with a receiving recess to receive the tool connector.

3. The socket assembly of claim 2, wherein
the receiving chamber of the insulating outer layer has a bottom wall formed with at least one positioning hole;
the receiving recess of the insulating outer layer has a bottom wall formed with at least one positioning bore;
the workpiece connector has a bottom wall provided with at least one positioning block locked in the positioning hole of the insulating outer layer;
the tool connector has a bottom wall provided with at least one positioning piece locked in the positioning bore of the insulating outer layer.

4. The socket assembly of claim 2, wherein
the receiving chamber of the insulating outer layer has a peripheral wall formed with a retaining flange;
the receiving recess of the insulating outer layer has a peripheral wall formed with a retaining rib;
the workpiece connector has a peripheral wall formed with a retaining groove locked onto the retaining flange of the insulating outer layer;
the tool connector has a peripheral wall formed with a retaining channel locked onto the retaining rib of the insulating outer layer.

5. The socket assembly of claim 4, wherein the retaining flange of the insulating outer layer has an annular shape;
the retaining rib of the insulating outer layer has an annular shape.

6. The socket assembly of claim 3, wherein
the positioning block of the workpiece connector has a rectangular shape;
the positioning piece of the tool connector has a rectangular shape.

7. The socket assembly of claim 3, wherein
the workpiece connector has an inner portion formed with a driving hole;
the positioning block of the workpiece connector is isolated from the driving hole;
the tool connector has an inner portion formed with a driven hole;
the positioning piece of the tool connector is isolated from the driven hole.

8. The socket assembly of claim 3, wherein the positioning piece of the tool connector and the positioning block of the workpiece connector are arranged in a staggered manner.

9. The socket assembly of claim 4, wherein
the retaining groove of the workpiece connector has an annular shape;
the retaining channel of the tool connector has an annular shape.

10. The socket assembly of claim 2, wherein the workpiece connector is fully received in and flush with the receiving chamber of the insulating outer layer.

11. The socket assembly of claim 2, wherein the tool connector is fully received in and flush with the receiving recess of the insulating outer layer.

12. The socket assembly of claim 3, wherein
the positioning block of the workpiece connector has an arc-shaped profile;
the positioning piece of the tool connector has an arc-shaped profile.

13. The socket assembly of claim 1, wherein the workpiece connector is a socket.

14. The socket assembly of claim 1, wherein the workpiece connector is a hexagonal driver.

15. The socket assembly of claim 1, wherein the workpiece connector is a connecting rod.

16. The socket assembly of claim 1, wherein the tool connector is preferably a T-shaped connecting tool and has at least one positioning piece.
